(19) United States
(12) Patent Application Publication
(10) Pub. No.: US 2015/0371244 A1
(43) Pub. Date: Dec. 24, 2015

(54) FORECASTING INFORMATION TECHNOLOGY WORKLOAD DEMAND

(71) Applicant: CA, INC., Islandia, NY (US)

(72) Inventors: Douglas M. Neuse, Austin, TX (US); Serguei Mankovskii, Santa Clara, CA (US)

(21) Appl. No.: 14/311,937

(22) Filed: Jun. 23, 2014

(51) Int. Cl. G06Q 30/02

(52) U.S. Cl. CPC G06Q 30/0202

(57) ABSTRACT

Embodiments of the disclosure describe methods and systems for improved forecasting of IT workloads and related metrics. Embodiments may include, for example, normalizing, warehousing and mining of data sets of many types collected from many different customers, applications and execution environments, and of metrics internal and external to such customers. Prediction or forecasting algorithms may be developed for predicting future IT workload demand based on a discovered relationship between certain factors and historical information. The prediction algorithms may be applied as appropriate to each customer's workloads, applications, and execution environments.

### TECHNICAL FIELD

The present disclosure relates generally to computer networks and information technology capacity planning.

### BACKGROUND

Current methods of managing, optimizing and planning information technology (IT) applications and infrastructures may be limited by a lack of knowledge about how IT workloads may change over time. IT data center managers, cloud service providers and other service providers may struggle to provide sufficient computing resources to meet demand at reasonable cost. Systems management software that merely reacts to current demand rather than anticipates future demand may not guarantee success.

However, future IT workload demand for computing resources may be difficult to predict. The demand may change over time as a result of changing business activity, seasonality, external media, end-user schedules and habits, random variation in user behavior, non-periodic events and/or other reasons. For example, FIG. 1 shows an IT workload capacity timeline. At the time of event A 106, factor(s) external to the IT workload information of a company, such as a discussion about a product or service of the company in social media, leads to a spike in demand 104. The IT resources 202 available at the time of event A 106 are insufficient to handle the demand spike 104. By the time IT capacity planners reactively build up (110) the IT resources of the company, the demand spike 104 has passed. Furthermore, event B 112 may be a planned restructuring of the business that lacks a prediction model.

Without accurate forecasts, IT capacity planners may be forced to over-configure their pools of resources to achieve required availability and service level agreements (SLAs). Such over-configuration may be expensive yet may still fail to consistently meet the availability requirements and SLAs. Without further considering the impact of external events on IT workload demand, demand forecasting may fail to provide accurate prediction models.

### BRIEF SUMMARY

Embodiments of the disclosure describe methods and systems for improved the forecasting of IT workload demand and related metrics. According to some embodiments, an information technology (IT) workload demand may be forecasted. Historic information external to IT workload information may be obtained. One or more explanatory variables associated with the historic external information may be identified. In some cases, these may be referred to as historic explanatory variables. An explanatory variable may be a variable that can contribute to, cause and/or explain a cause of a change in IT demand workload volume. A historic IT workload demand resulting from the historic explanatory variable(s) may be determined. A predictive algorithm for forecasting the future IT workload demand may be generated based on the explanatory variable(s) and the historic IT workload demand.

In further embodiments, external information, such as current external information, may then be obtained. The external information may be external to the IT workload information. The external information may include external media business information or a future business event. An explanatory variable or variables associated with the external information may be identified and a predictive algorithm may be selected from among predictive algorithms based on a comparison of the explanatory variable(s) of the external information to the historic explanatory variable(s) of the historic external information. The future IT workload demand for the external information may be calculated with the predictive algorithm.

According to some embodiments, a system may include a processor and a memory coupled to the processor and comprising computer readable program code embodied in the memory that when executed by the processor causes the processor to perform operations. The operations may include obtaining historic information external to IT workload information, identifying a historic explanatory variable associated with the historic information, determining a historic IT workload demand resulting from the historic explanatory variable and generating a predictive algorithm for forecasting the future IT workload demand based on the explanatory variable and the historic IT workload demand.

According to some embodiments, a computer program product may include a non-transitory computer readable storage medium comprising computer readable program code embodied in the medium that when executed by a processor causes the processor to perform operations. The operations may include obtaining historic information external to IT workload information, identifying a historic explanatory variable associated with the historic information, determining a historic IT workload demand resulting from the historic explanatory variable and generating a predictive algorithm for forecasting the future IT workload demand based on the explanatory variable and the historic IT workload demand.

Various embodiments may include methods, systems and computer program products. It is noted that aspects described with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Embodiments of the present disclosure are illustrated by way of example and are not limited by the accompanying figures with like references indicating like elements.

FIG. 1 is a diagram of a capacity planning timeline;

FIG. 2 illustrates a system for generating prediction algorithms, according to various embodiments;

FIG. 3A illustrates a flowchart of a process for generating predictive algorithms, according to various embodiments;

FIG. 3B illustrates a flowchart of a process for forecasting an IT workload demand, according to various embodiments;

FIG. 4 illustrates a system for forecasting an IT workload demand, according to various embodiments; and

FIG. 5 is a block diagram of a computing device in which various embodiments can be implemented.

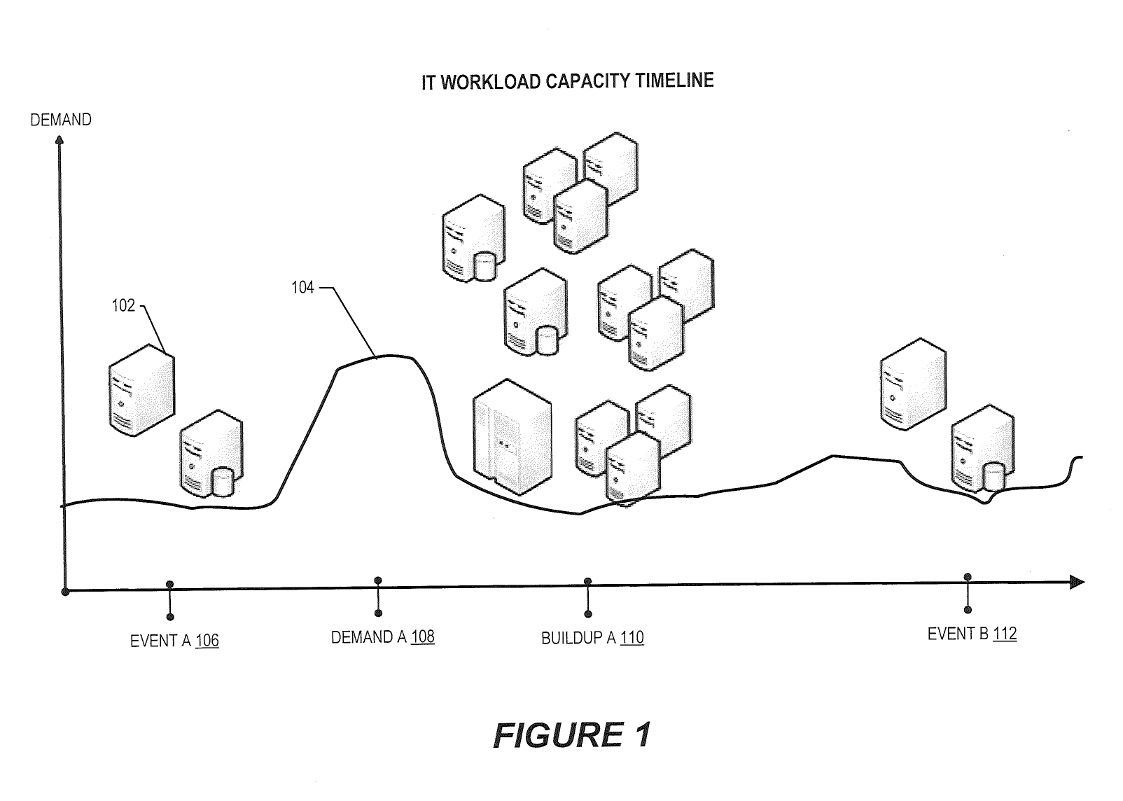

### DETAILED DESCRIPTION

Embodiments of the present disclosure will be described more fully hereinafter with reference to the accompanying drawings. Other embodiments may take many different forms and should not be construed as limited to the embodiments set forth herein.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Current methods of managing, optimizing and planning information technology (IT) applications and infrastructures may be limited by a lack of knowledge about how IT workloads will change over time. Embodiments of the present disclosure allow for future workload activity and resource consumption to be better predicted. As a result, IT system managers could plan an orderly expansion of data center computing resources that meets growing demand at minimal cost and power consumption. Bottlenecks and other performance problems could be predicted and avoided. Problems may be solved before they occur. Computing environments could be continuously optimized to achieve the most attractive balance of performance and cost while avoiding disruptions of service.

A typical capacity planning project may start with a collection of resource consumption data such as CPU and memory utilization of the servers in a data center. The capacity planner may identify a baseline period that is supposed to be a representative starting point for a predictive model. A model may be built to simulate the data center as represented by the baseline period data. The user may specify hypothetical changes to the data center such as increases in the workloads or changes to the system hardware and software configurations. The model may then predict the resulting resource utilizations and perhaps response times that will result if the hypothetical changes are realized. Similarly, current data center optimization and load balancing technologies may attempt to identify system configuration changes that will achieve optimality with respect to very recent workload behavior. In capacity planning, the predictions may be seriously flawed if the selected baseline or user-specified workload changes are not representative of the future. In optimization, the recommended system changes may be seriously flawed if the recent past is not representative of the future. If future workload demand volumes were known, planning and optimization could achieve better results.

Embodiments described herein may include, for example, mining, normalizing and warehousing one or more of the metrics characterizing the potential forces directly or indirectly influencing IT workload demand changes. These metrics may be obtained from many types of data sets from many different customers, applications and execution environments. These metrics may include those metrics external to common IT workload statistics. Data may be mined across types, across customers and across organizational boundaries. Forecasting or prediction algorithms may be developed for predicting future IT workload demand based on a relationship discovered between certain factors and/or historic information. The prediction algorithms may be applied as appropriate to each customer's workloads, applications, and execution environments.

According to some embodiments, IT workload demand may include information such as transactions per second or resource consumption. Transactions per second may provide for anomaly prediction in addition to capacity planning or other capacity analysis.

According to some embodiments, the historic information may include historic media business information. Historic media business information may include an online publication, a blog, social media posting or other comments with a reference to a product. A product, as used herein, may also be a service or include a service. The explanatory variable may include an amount of the historic media business information. The predictive algorithm may be generated based on a correspondence between the amount of the historic external media business information and a following increase in the historic IT workload demand.

Historic information may include information about past workload demand and past resource consumption. The historic information may include common IT resource information such as CPU usage, memory storage, number and configuration of virtual machines, computing device configuration information, computing device performance statistics, number and type of computing devices, electrical power usage, data center server information and other past information commonly pertaining to IT resource management.

Historic external information may also include information that is external to the IT department and IT capacity planners. This information may be information external to IT workload information that is not commonly associated with IT hardware and software usage as explained above. For example, the historic external information may include historic external media business information and/or a historic business event. External media business information may include social media posts, blog posts, online publication articles, print articles, news reports or other information publicly posted by people inside or outside the company that relate to the business of the company or a product (or service) of the company.

Business events are events that may be planned and/or are decided upon by the management of the company. This information may are may not be provided to the IT capacity planning department. For example, a planned acquisition, merger, sale, reorganization, layoff, deal, trade and/or any other business event that affects the amount of deliverables of a company may be planned for a future date. Business events are not limited to business reorganizations or acquisitions, but may also include other business metrics, such as sales volume. These business events (including metrics) may be found in business plans of a business.

Explanatory variables associated with the historic external information may be identified. Explanatory variables are factors or variables that can cause, contribute to and/or explain a change in IT demand workload volume. A historic IT workload demand resulting from an explanatory variable may be determined. A predictive algorithm for forecasting the future IT workload demand may be generated based on an explanatory variable and a resulting historic IT workload demand.

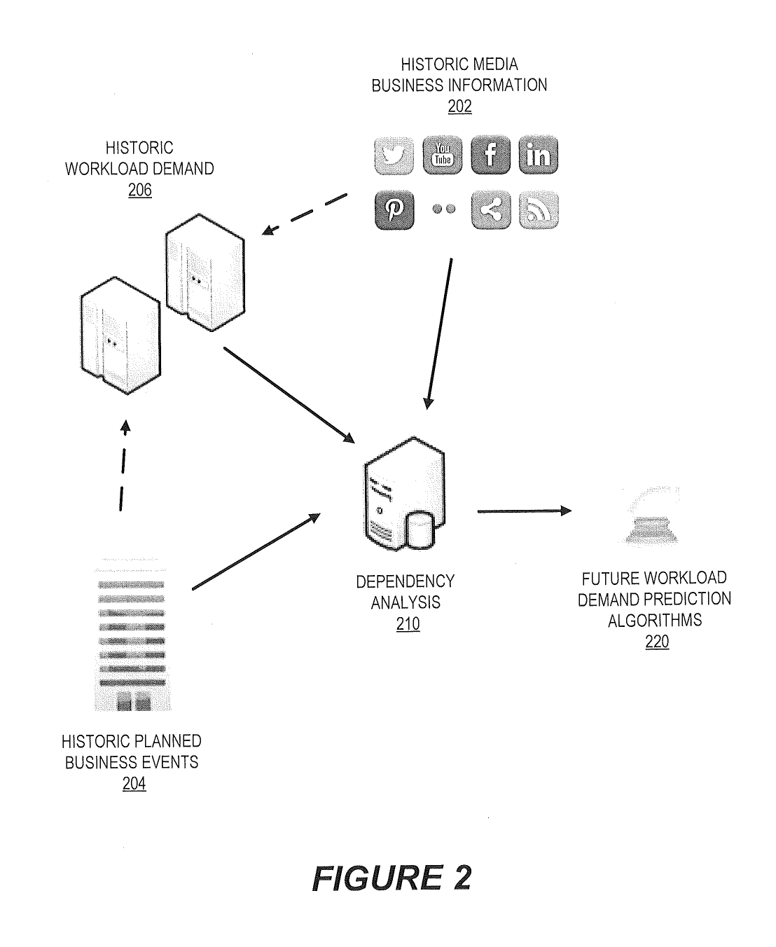

For example, FIG. 2 shows a collection of historical information, according to some embodiments. Historic workload demand information 206 may be collected. This information may be IT workload demand and resource consumption information.

Historic media business information 202 may be collected. This information may include public commentary, verbal or written. Automatic web crawlers may obtain this information from online comments. This information may also be provided by third party services. Historic workload demand information 206 resulting from the historic media business information 202 may be analyzed and collected. Historic business event information, which may include historic information from planned business events 204, may be collected. Historic workload demand information 206 resulting from the planned business events 204 may be analyzed and collected.

The information may be analyzed and collected as part of a dependency analysis 210. Explanatory variables and causal relationships may be identified and used to generate future workload demand prediction algorithms 220.

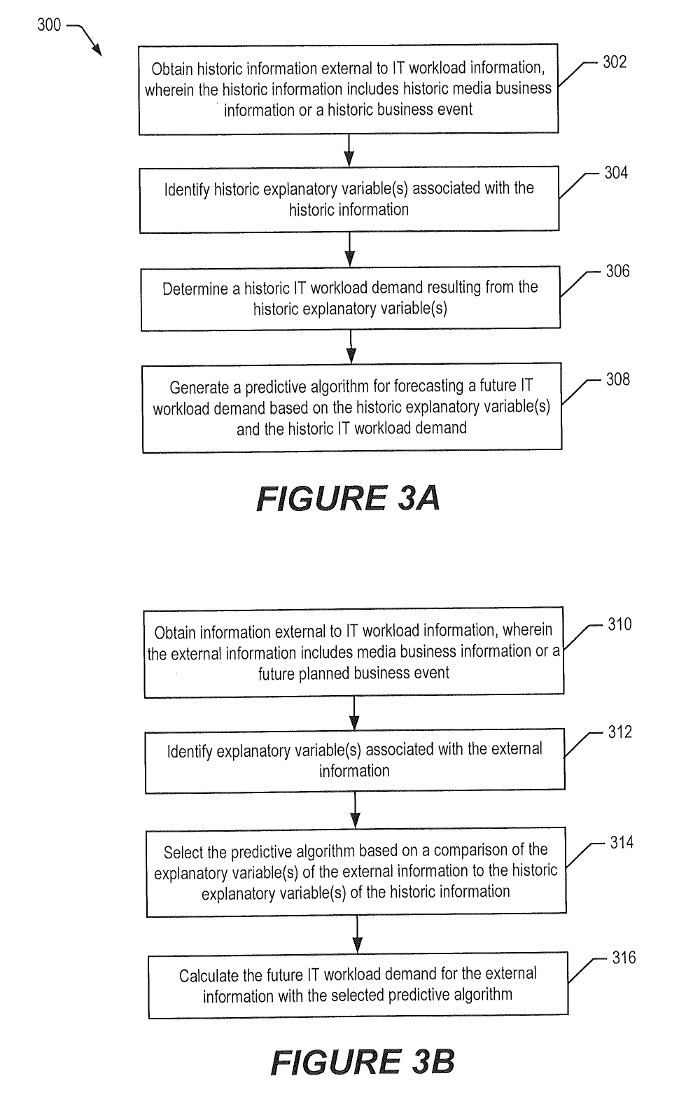

FIG. 3A illustrates a flowchart for a process for generating predictive algorithms, according to some embodiments. FIG. 3B illustrates a flowchart for a process for forecasting future IT workload demand, according to some embodiments. In block 302, historic external information is obtained. The historic external information may include historic external media business information and/or historic business event information. Mined data sets may include, but are not limited to, business metrics and social media discussions. It may not be necessary to construct a single monolithic warehouse from such metrics. Rather, it may be beneficial for mining queries and algorithms to have access to one or more of the metrics characterizing major potential forces directly or indirectly influencing workload changes in a sufficiently effective form.

A direct force is one that acts directly upon a workload metric of interest. For example, the number of users of an online stock-trading system and the frequency of trades per user directly influence the overall stock trading transaction volume. An indirect force acts through other indirect or direct forces. For example, the quarterly financial forecasts by a company influence overall stock trading transaction volume indirectly by influencing the attractiveness of the stock and the corresponding transaction volume per user as well as (eventually) the number of users.

In some cases, a direct force can be minor and an indirect one may be major. Metrics characterizing direct or indirect forces with minor influence can be ignored or weighted less. In some embodiments, it may be beneficial to warehouse all such metrics until mining confirms which forces are major versus minor.

In block 304, one or more explanatory variables associated with the historic external information are identified. These may be referred to as historic explanatory variables. Multiple factors or variables associated with historic external information may be parsed, organized, grouped, merged, isolated and/or categorized from available information. Explanatory variables may be identified from these factors or variables. Some variables may be found to be more related to changes in workload demand than others. A variable determined to have a certain level of causality on workload demand may be considered an explanatory variable if its causality satisfies a causality threshold.

For example, if a number of social media comments about a product may have resulted in an increase in workload demand, the number of social media comments may be considered a variable. If a 25% increase in the number of social media comments results in at least a 15% increase in server usage within a certain time period, the number of social media comments may satisfy a causality threshold and be identified as an explanatory variable.

In some embodiments, to be more effective, the data may be sufficiently normalized. Such normalization requires consistency in (or the conversion of) metric names, definitions and concepts, dates, times, units and/or other characteristics.

A historic IT workload demand resulting from the explanatory variable(s) is determined (block 306). IT information related to a change or pattern in IT workload demand may be collected. Such metrics may be used for forecasting future IT workload demand and resource requirements necessary to meet the demand.

A predictive algorithm for forecasting the future IT workload demand is generated based on the explanatory variable(s) and the historic IT workload demand (block 308). The predictive algorithm may include explanatory variables and relationships between values of the explanatory variables and the resulting IT workload demand.

According to some embodiments, the predictive algorithm may include a predictive metric corresponding to an amount that the explanatory variable causes the future IT workload demand. The predictive algorithm may be included in a set of predictive algorithms responsive to a determination that the predictive metric of the predictive algorithm satisfies a predictive metric threshold.

According to some embodiments, a set of predictive algorithms may be generated by obtaining historic external information, identifying an explanatory variable, determining a historic IT workload demand and generating a predictive algorithm for multiple pieces of historic external information. Predictive algorithms may be selected from among the set of predictive algorithms. Predictive algorithms may also be recalculated responsive to obtaining additional historic external information.

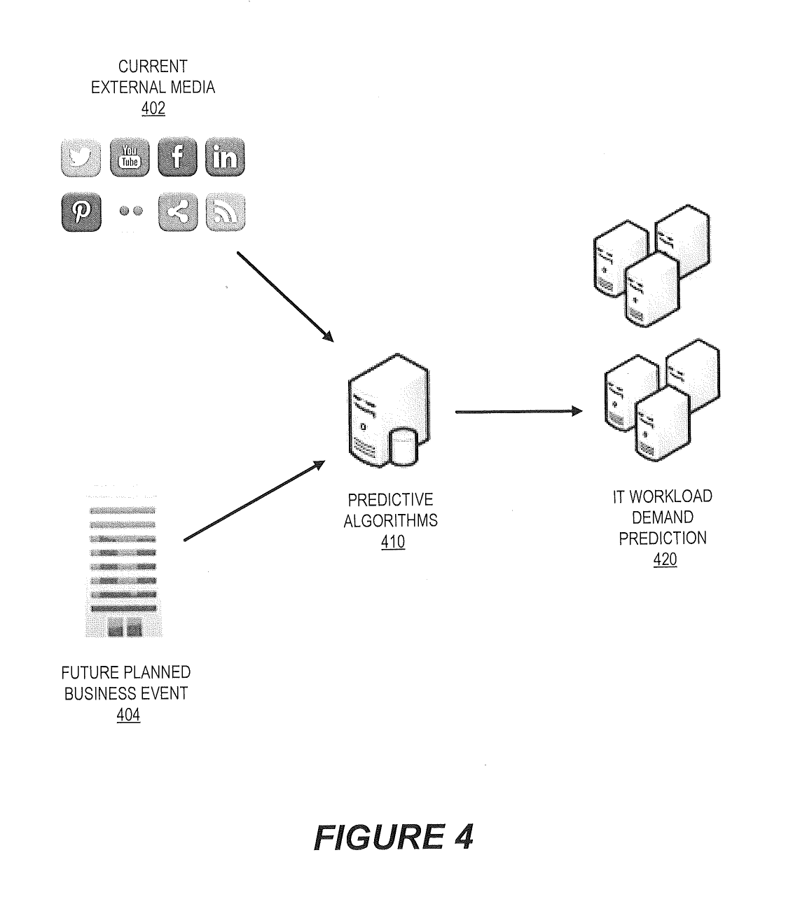

Predictive algorithms may be generated and organized into sets of predictive algorithms. These predictive algorithms may be searched for and selected from to predict future IT workload demand based on current events. For example, FIG. 4 illustrates possible external information. External media 402 may indicate an increase in interest of a product of the business. Explanatory variables of the external media are identified and compared to explanatory variables of the predictive algorithms 410. If the explanatory variables of the predictive algorithms 410 are found to be related or to match to some degree the explanatory variables of the external information, the one or more predictive algorithms 410 are selected and used to calculate a future IT workload demand prediction 420.

According to some embodiments, some predictive algorithms may be generated, selected or organized based on an application type or a workload type. For example, one prediction algorithm may be generated and selected for use in capacity requirement planning while another prediction algorithm may be generated and selected as more applicable for online shopping.

Likewise, if a future business event 404, planned or unplanned, is to take place, the future IT workload demand may need to be predicted to account for any changes in the organization, personnel, deliverables or any other change in resource capacity. Explanatory variables are determined and compared to explanatory variables of the predictive algorithms 410. Future IT workload demand is then calculated.

The flowchart of FIG. 3B continues with the obtaining of external information, which may represent current external information. At block 310, external information may be obtained. The external information may include external media business information or a future business event. One or more explanatory variables associated with the external information may be identified (block 312).

At block 314, the predictive algorithm is selected based on a comparison of the explanatory variable(s) of the external information to the explanatory variable(s) of the historic external information. These comparisons may result in matches between explanatory variables. In some cases, categories or other descriptive parameters of the explanatory variables may be compared in the event that the explanatory variables vary in name but are similar in purpose and effect.

The future workload demand for the external information is calculated with the selected predictive algorithm (block 316). Explanatory variables and values may be entered into the predictive algorithm formula, relationship or equation. This may result in metrics or values that can be interpreted or converted to IT workload demand metrics. In some cases, the resources required to meet the demands may be calculated as well.

In an example, the merger of two large companies often results in the eventual consolidation of the information systems of those companies. The historical trends found in the IT metrics of the data center that will host the consolidated information system will not reveal the changes in workload volumes and resource consumption that will occur during and after the consolidation. However, the business plans and forecasts of the two companies together with their historical workload volumes and resource consumption may very well contain sufficient information to predict the combined future workload volumes and resource consumption.

Similarly, when a company releases a new product that turns out to be very popular, the sales and support systems for those products may see a large increase in traffic not evident in the historical workload metrics from those systems. However, the related discussions in social media following the product's announcement may indicate the product's future popularity, which may indicate the future sales and support volume, which may indicate the future increase in the related sales and support traffic. Forecasting techniques that rely solely on historical IT workload metrics and ignore the social media discussions may forecast future IT workload metrics poorly compared to embodiments described herein.

In some embodiments, machine learning techniques may be applied to improve and revise the prediction algorithms and causality information for the effects on the workload volumes and resource consumption resulting from all the factors or variables that influence them. Learning, recalculating and improving may take place on an ongoing basis.

Explanatory variables may have varying amounts of effect on an IT workload demand volume. The amount of causality may be determined, collected and analyzed. In some cases such causality analysis may result in causality values and causality operations that help to explain and/or predict the effect that certain explanatory variables may have on IT workload demand.

For example, the frequency of occurrences of the name of a newly released product in social media may be very strongly correlated to subsequent traffic to the product vendor's web site and moderately correlated with traffic to the product vendor's online sales site. In another example, a company with a history of releasing inferior products may see less strong correlations of this kind, so the history of such correlations themselves may be beneficial to capture.

Those dependencies and other relationships are embedded in a variety of competing predictive models or algorithms. Predictive algorithms may be represented as equations, with explanatory variables, causality values and/or causality operations. For example, the number of online product sale transactions of a “Big Goofy Monster Toy” in month m may depend upon explanatory variables, such as the corresponding advertising dollars and social media traffic in month m−1. Variables a₀, a₁ and a₂ may be constants or causality values that help to quantify an effect of explanatory variables. Therefore, a corresponding predictive algorithm may include the following:

Sales transactions(m)=a₀+a₁*Advertising(m−1)+a₂*Social media traffic(m−1)

Such models are trained and tested on the collected data sets in order to evaluate and select the algorithms and configuration parameters that best forecast workload volumes and resource consumption for each workload, application and execution environment type.

In the example above, the data mining could also generate the following values:

a₀=1000, a₁=0.5 per dollar, a₂=0.02 per tweet

In another example, the mining might discover a very different predictive form, such as:

Sales transactions(m)=1000+a₁*(Advertising(m−1))²*a₂*(Social media traffic(m−1))^{0.5}

In this case, the sensitivity of future transaction volume to advertising is more than linear whereas its sensitivity to social media traffic is less than linear.

The usefulness of explanatory variables may be determined by assigning causality values. Explanatory variables having causality variables that satisfy a certain causality threshold will be indicated as explanatory variables and may be candidates for elements of an equation that form a prediction algorithm.

According to some embodiments, the predictive algorithm may include an equation comprising the explanatory variable, a causality value and a causality operation. A causality value may be an indicator, flag, metric or other relationship marker that indicates or indicates how much an explanatory variable is responsible or likely responsible for causing demand or consumption of a resource or a change in a demand or consumption of a resource. Future IT workload demand may be calculated using the causality operation to operate on the explanatory variable with the causality value.

According to some embodiments, the predictive algorithm comprises a timeframe and the timeframe of the predictive algorithm may be calculated based on a timeframe of the historic IT workload demand, and a timeframe of the future IT workload demand may be calculated based on the timeframe of the predictive algorithm.

According to some embodiments, an explanatory variable associated with the historic external information having a linear effect or a nonlinear effect on the historic IT workload demand that satisfies a causality threshold may be identified. A causality threshold may be a threshold, standard or metric that a causality value of an explanatory variable or potential explanatory variable must satisfy for the explanatory variable to be considered a cause of a demand or consumption of a resource or a change in the demand or consumption of a resource. If this causality threshold is not satisfied, then a potential explanatory variable may not be considered to be an explanatory variable or an explanatory variable that had any or will have any significant or substantial influence on IT workload demand.

According to some embodiments, a historic business event, which may have been a planned or foreseen business event at the time, may include a release of a product. The explanatory variable may include a time of the release of the product. The predictive algorithm may be generated based on a correspondence between the time of the release of the product and a following increase in the historic IT workload demand.

According to some embodiments, the historic business event may include a restructure of a business, such as a merger, acquisition, separation or other reorganization of the business. The explanatory variable may include a change in the amount of deliverables of the business. The predictive algorithm may be generated based on a correspondence between the change in the amount of deliverables and a following increase in the historic IT workload demand.

This process of data set collection, mining, and algorithm discovery and improvement may be applied on an ongoing basis, with the improved algorithms periodically implemented in new versions of capacity planning and optimization products and distributed to customers.

The predictive algorithms may be applied to a particular customer's workloads, applications and/or execution environments. For a particular customer, the historical workload volumes and resource consumption together with the related historical and forecasted metrics of all the factors that influence, or may influence, them are collected and warehoused. This data collection and warehousing, as well as the forecasting, modeling, capacity planning, optimization and/or machine learning may continue on an ongoing basis.

The prediction algorithms generated as described above are applied to this current data in order to forecast future workload volumes and resource consumption. These forecasts are also used in models in order to produce better capacity planning and optimization predictions, recommendations and/or decisions. Machine learning techniques may be applied to the forecasting model inputs, outputs and/or eventual actual metric values in order to improve the forecasting models for this customer. These forecasting techniques and the process for developing them may be applied to metrics other than workload volumes and resource consumption and their use in capacity planning and optimization models. For example, the forecasts may be applicable to predictive anomaly detection problems and even to business metric forecasting.

The improved planning and optimization can benefit a variety of people and organizations. End users may experience better performance and reliability at lower cost. Service providers may meet their workload demand and service level agreements at lower cost and power consumption. Systems management products may improve and the public may see reduced power consumption by IT activity and economic, improvements resulting from better IT business efficiency.

In some embodiments, IT workload resources may include computing devices, such as servers in a virtualized computing environment. The server system may generally host one or more virtual machines, each of which includes a CPU and memory capacity for running an operating system and/or various applications. A virtual hypervisor may provide an interface between the virtual machines and a host operating system and allow multiple guest operating systems and associated applications to run concurrently. The host operating system handles the operations of a hardware platform capable of implementing virtual machines. A data storage space may be accessed by the host operating system and is connected to the hardware platform.

The hardware platform generally refers to any computing system capable of implementing virtual machines, which may include, without limitation, a mainframe, personal computer (PC), handheld computer, mobile computing platform, server, or any other appropriate computer hardware. The hardware platform may include computing resources such as a central processing unit (CPU); networking controllers; communication controllers; a display unit; a program and data storage device; memory controllers; input devices (such as a keyboard, a mouse, touch screen, etc.) and output devices such as printers. The CPU may be any conventional processor, such as the AMD Athlon™ 64, or Intel® Core™ Duo processor sets.

The hardware platform may be further connected to the data storage space through serial or parallel connections. The data storage space may be any suitable device capable of storing computer-readable data and instructions, and it may include logic in the form of software applications, random access memory (RAM), or read only memory (ROM), removable media, or any other suitable memory component. The host operating system may stand between the hardware platform and the users and may be responsible for the management and coordination of activities and the sharing of the computing resources.

Each virtual machine may be controlled by an agent and have a network interface. The network interface manages communications with other virtual machines. The virtual machines are communicatively coupled via a network. The network facilitates wireless or wireline communication, and may communicate using, for example, IP packets, Frame Relay frames, Asynchronous Transfer Mode (ATM) cells, voice, video, data, and other suitable information between network addresses. The network may include one or more local area networks (LANs), radio access networks (RANs), metropolitan area networks (MANS), wide area networks (WANs), all or a portion of the global computer network known as the Internet, and/or any other communication system or systems at one or more locations.

In an embodiment, the methods and systems for FIGS. 2-4 may operate through a browser on a node or computing device. The browser may be any commonly used browser, including any multithreading browser.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented as entirely hardware, entirely software (including firmware, resident software, micro-code, etc.) or combined software and hardware implementation that may all generally be referred to herein as a “circuit,” “module,” “component,” or “system.”

As will be appreciated by one skilled in the art, aspects of the disclosure may be embodied as a method, data processing system, and/or computer program product. Furthermore, embodiments may take the form of a computer program product on a tangible computer readable storage medium having computer program code embodied in the medium that can be executed by a computing device.

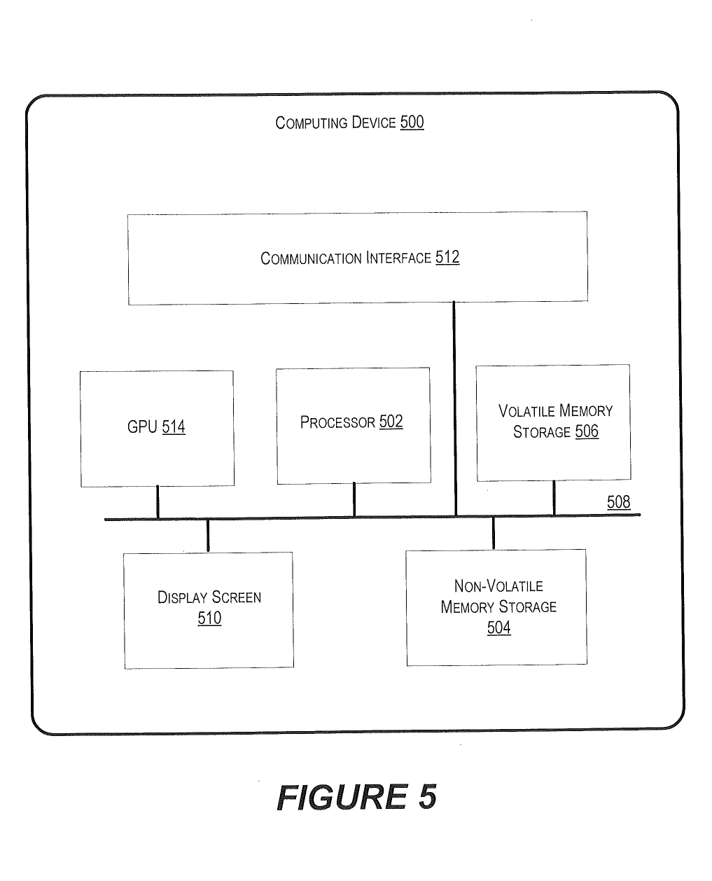

FIG. 5 is an example computer device 500 in which embodiments of the present disclosure, or portions thereof, may be implemented as computer-readable code. For example, the components of the methods and systems of FIGS. 2-4 or any other components thereof may be implemented in one or more computer devices 500 using hardware, software implemented with hardware, firmware, tangible computer-readable storage media having instructions stored thereon, or a combination thereof and may be implemented in one or more computer systems or other processing systems. Computer devices 500 may also be virtualized instances of computers. Components and methods in FIGS. 2-4 may be embodied in any combination of hardware and software.

Computing device 500 may include one or more processors 502, one or more non-volatile storage mediums 504, one or more memory devices 506, a communication infrastructure 508, a display screen 510 and a communication interface 512. Computing device 500 may also have networking or communication controllers, input devices (keyboard, a mouse, touch screen, etc.) and output devices (printer or display).

Processor(s) 502 are configured to execute computer program code from memory devices 504 or 506 to perform at least some of the operations and methods described herein, and may be any conventional or special purpose processor, including, but not limited to, digital signal processor (DSP), field programmable gate array (FPGA), application specific integrated circuit (ASIC), and multi-core processors.

GPU 514 is a specialized processor that executes instructions and programs, selected for complex graphics and mathematical operations, in parallel.

Non-volatile memory storage 504 may include one or more of a hard disk drive, flash memory, and like devices that may store computer program instructions and data on computer-readable media. One or more of non-volatile storage memory 504 may be a removable storage device.

Volatile memory storage 506 may include one or more volatile memory devices such as but not limited to, random access memory. Communication infrastructure 508 may include one or more device interconnection buses such as Ethernet, Peripheral Component Interconnect (PCI), and the like.

Typically, computer instructions are executed using one or more processors 502 and can be stored in non-volatile memory storage 504 or volatile memory storage 506.

Display screen 510 allows results of the computer operations to be displayed to a user or an application developer.

Communication interface 512 allows software and data to be transferred between computer system 500 and external devices. Communication interface 512 may include a modem, a network interface (such as an Ethernet card), a communications port, a PCMCIA slot and card, or the like. Software and data transferred via communication interface 512 may be in the form of signals, which may be electronic, electromagnetic, optical, or other signals capable of being received by communication interface 512. These signals may be provided to communication interface 512 via a communications path. The communications path carries signals and may be implemented using wire or cable, fiber optics, a phone line, a cellular phone link, an RF link or other communications channels. According to an embodiment, a host operating system functionally interconnects any computing device or hardware platform with users and is responsible for the management and coordination of activities and the sharing of the computer resources.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, JavaScript, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Embodiments of the present disclosure are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described embodiments or any actual software code with the specialized control of hardware to implement such embodiments, but should be defined only in accordance with the following claims and their equivalents.

What is claimed is:

1. A method of forecasting an information technology (IT) workload demand, comprising:
obtaining historic information external to IT workload information;
identifying a historic explanatory variable associated with the historic information;
determining a historic IT workload demand resulting from the historic explanatory variable; and
generating, by a computing device, a predictive algorithm for forecasting a future IT workload demand based on the historic explanatory variable and the historic IT workload demand.

2. The method of claim 1, wherein the method further comprises:
obtaining external information that is external to IT workload information;
identifying an explanatory variable associated with the external information;
selecting the predictive algorithm based on a comparison of the explanatory variable of the external information to the historic explanatory variable of the historic information; and
calculating the future IT workload demand for the external information with the predictive algorithm.

3. The method of claim 2, wherein the predictive algorithm comprises an equation comprising the historic explanatory variable, a causality value and a causality operation, and wherein calculating the future IT workload demand comprises using the causality operation to operate on the explanatory variable with the causality value.

4. The method of claim 2, wherein the predictive algorithm comprises a timeframe, and wherein the method further comprises:
calculating the timeframe of the predictive algorithm based on a timeframe of the historic IT workload demand; and
calculating a timeframe of the future IT workload demand based on the timeframe of the predictive algorithm.

5. The method of claim 1, wherein the predictive algorithm comprises a predictive metric corresponding to an amount that the historic explanatory variable contributes to the historic IT workload demand, and wherein the method further comprises including the predictive algorithm in a set of predictive algorithms responsive to a determination that the predictive metric of the predictive algorithm satisfies a predictive metric threshold.

6. The method of claim 1, further comprising recalculating the predictive algorithm responsive to obtaining additional historic information.

7. The method of claim 1, wherein the historic information comprises historic media business information with a reference to a product, wherein the historic explanatory variable comprises an amount of the historic media business information, and wherein generating the predictive algorithm comprises generating the predictive algorithm based on a correspondence between the amount of the historic media business information and a subsequent increase in the historic IT workload demand.

8. The method of claim 7, wherein the historic media business information comprises a social media posting with a reference to the product.

9. The method of claim 1, wherein the historic information indicates a release of a product, wherein the historic explanatory variable comprises a time of the release of the product, and wherein generating the predictive algorithm comprises generating the predictive algorithm based on a correspondence between the time of the release of the product and a subsequent increase in the historic IT workload demand.

10. The method of claim 1, wherein the historic information indicates a restructure of a business, wherein the explanatory variable comprises a change in an amount of deliverables of the business, and wherein generating the predictive algorithm comprises generating the predictive algorithm based on a correspondence between the change in the amount of deliverables and a subsequent increase in the historic IT workload demand.

11. A system, comprising:
a processor; and
a memory coupled to the processor and comprising computer readable program code embodied in the memory that when executed by the processor causes the processor to perform operations comprising:
obtaining historic information external to IT workload information;
identifying a historic explanatory variable associated with the historic information;
determining a historic IT workload demand resulting from the historic explanatory variable; and
generating, by a computing device, a predictive algorithm for forecasting a future IT workload demand based on the historic explanatory variable and the historic IT workload demand.

12. The system of claim 11, wherein the operations further comprise:
obtaining external information that is external to IT workload information;
identifying an explanatory variable associated with the external information;
selecting the predictive algorithm based on a comparison of the explanatory variable of the external information to the historic explanatory variable of the historic information; and
calculating the future IT workload demand for the external information with the predictive algorithm.

13. The system of claim 12, wherein the predictive algorithm comprises an equation comprising the historic explanatory variable, a causality value and a causality operation, and wherein the operations further comprise using the causality operation to operate on the explanatory variable with the causality value.

14. The system of claim 12, wherein the predictive algorithm comprises a predictive metric corresponding to an amount that the historic explanatory variable contributes to the historic IT workload demand, and wherein the operations further comprise including the predictive algorithm in a set of predictive algorithms responsive to a determination that the predictive metric of the predictive algorithm satisfies a predictive metric threshold.

15. The system of claim 12, wherein the predictive algorithm comprises a timeframe, and wherein the operations further comprise:
calculating the timeframe of the predictive algorithm based on a timeframe of the historic IT workload demand; and
calculating a timeframe of the future IT workload demand based on the timeframe of the predictive algorithm.

16. The system of claim 11, wherein the operations further comprise recalculating the predictive algorithm responsive to obtaining additional historic information.

17. The system of claim 11, wherein the historic information comprises historic media business information with a reference to a product, wherein the historic explanatory variable comprises an amount of the historic media business information, and wherein the operations further comprise generating the predictive algorithm based on a correspondence between the amount of the historic media business information and a subsequent increase in the historic IT workload demand.

18. The system of claim 11, wherein the historic information comprises a release of a product, wherein the historic explanatory variable comprises a time of the release of the product, and wherein the operations further comprise generating the predictive algorithm based on a correspondence between the time of the release of the product and a subsequent increase in the historic IT workload demand.

19. The system of claim 11, wherein the historic information comprises a restructure of a business, wherein the historic explanatory variable comprises a change in the amount of deliverables of the business, and wherein the operations further comprise generating the predictive algorithm based on a correspondence between the change in the amount of deliverables and a subsequent increase in the historic IT workload demand.

20. A computer program product, comprising:
a non-transitory computer readable storage medium comprising computer readable program code embodied in the medium that when executed by a processor causes the processor to perform operations comprising:
obtaining historic information external to IT workload information;
identifying an explanatory variable associated with the historic information;
determining a historic IT workload demand resulting from the explanatory variable; and
generating, by a computing device, a predictive algorithm for forecasting a future IT workload demand based on the explanatory variable and the historic IT workload demand.
